(19) United States
(12) Patent Application Publication
(10) Pub. No.: US 2004/0112028 A1
(43) Pub. Date: Jun. 17, 2004

(54) Mulching lawn mower blade assembly with replaceable inserts

(76) Inventors: C. Lee Duncan, Lewistown, IL (US); Allen J. LaRiviere, Ipava, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/728,397

(22) Filed: Dec. 5, 2003

Related U.S. Application Data
(60) Provisional application No. 60/431,089, filed on Dec. 5, 2002.

(51) Int. Cl. A01D 34/73

(52) U.S. Cl. 56/295

(57) ABSTRACT

A mulching lawn mower blade assembly having replaceable inserts and mulching teeth. The mulching teeth may be located on the replaceable inserts or the mulching blade. A sickle insert is disclosed for use in tall grass. The mulching lawn mower blade assembly may include means for sand to flow over the mulching teeth in high sand areas.

### CROSS-REFERENCE TO RELATED APPLICATIONS

This application claims priority from U.S. Provisional Patent Application No. 60/431089 filed Dec. 5, 2002.

### BACKGROUND OF THE INVENTION

The present invention relates generally to lawn mower blades and in particular the present invention relates to a mulching lawn mower blade assembly.

Lawns of American homes are maintained by cutting grass with a lawn mower. These lawn mowers are either manually powered or powered by an engine to rotate a cutting blade. Powered lawn mower engines can be operated using gas or electric energy and reduce the effort required by a manual lawn mower. As a result of environmental concerns, the design and use of power lawn mowers with mulching operation are now widespread. The mulching lawn mower is specifically designed to circulate cut grass under the lawn mower such that it is re-cut to a fine mulch. To accomplish this, the bottom surface of the lawn mower is generally shaped like a doughnut and a special mulching blade is used. The combination of these features creates a swirling action to direct cut grass toward the center of the mower where it is re-cut and then deposited on the lawn without being discharged from the mower through a shoot.

Rotary lawn mowers are by far the most common type of mower used by homeowners. In addition, both single and multi-blade rotary mowers are used in large scale commercial operations. The blades in these mowers are in almost all cases a flat, rectangular steel blade sharpened on the leading edge at each end of the blade to form a cutting edge. Depending upon how careful the user is and the amount of use of the mower, the blade should be sharpened several times a year. In order to properly sharpen the blade, the blade or blades should be removed from the mower. This requires a considerable amount of time and the proper tools, and it is not a task that the homeowner can easily perform himself. Most commonly, the user must transport the mower to a professional repair shop where the blade can be properly and professionally balanced and sharpened. This of course is costly and, after repeated sharpening, the blade must be replaced. Another disadvantage is downtime. During the Spring and Summer seasons repair shops have a considerable backlog, and their turnaround time for maintenance and repairs can be excessive.

For the reasons stated above, and for other reasons stated below which will become apparent to those skilled in the art upon reading and understanding the present specification, there is a need in the art for a mulching lawn mower blade assembly having replaceable inserts which can mulch cut grass and provide an efficient way to achieve a properly sharpened cutting blade.

### BRIEF SUMMARY OF THE INVENTION

It is a principal aspect of the present invention to provide a mulching lawn mower blade assembly with replaceable inserts which produces a fine mulch of grass clippings and distributes them evenly into the uncut grass at soil level without clogging in the lawn mower housing and without producing clumps of clippings.

It is another aspect of the present invention to provide a mulching lawn mower blade assembly with replaceable inserts wherein the replaceable inserts are capable of being quickly swapped.

It is yet another aspect of the present invention to provide a mulching lawn mower system with replaceable inserts characterized in that the replaceable inserts may be designed to function in specific types of environments.

In still another aspect of the present invention to provide a mulching lawn mower blade assembly with replaceable inserts wherein the replaceable inserts may be removed, rotated, and reattached to provide a sharp cutting edge.

The above aspects are accomplished by a mulching lawn mower blade assembly with replaceable inserts comprising a lawn mower blade and two cutting inserts, with either the mower blade or the cutting inserts including inclined teeth for mulching.

Further features and advantages of the present invention, as well as the structure and operation of various embodiments of the present invention, are described in detail below with reference to the accompanying drawings.

### BRIEF DESCRIPTION OF THE DRAWINGS

Reference is now made to the accompanying drawings which illustrate the best known mode for carrying out the invention:

FIG. 1a is a top view of a mulching lawn mower blade assembly with replaceable inserts;

FIG. 1b is a side view of the embodiment shown in FIG. 1a;

FIG. 2a is a front view of a lawn mower mulching blade portion illustrating a first embodiment;

FIG. 2b is a side view of the lawn mower mulching blade portion shown in FIG. 2a;

FIG. 2c is a top view of the mulching lawn mower blade portion shown in FIG. 2a;

FIG. 3a is a side view of an insert illustrating a first embodiment;

FIG. 3b is a top view of the insert shown in FIG. 3a;

FIG. 4a is a side view of a sickle insert illustrating a second embodiment;

FIG. 4b is a top view of the sickle insert shown in FIG. 4a;

FIG. 5a is a side view of a lawn mower blade portion illustrating a third embodiment;

FIG. 5b is a top view of the lawn mower blade portion shown in FIG. 5a;

FIG. 6a is a side view of a mulching insert illustrating a third embodiment;

FIG. 6b is a top view of the mulching insert shown in FIG. 6a;

FIG. 7 is a side view of a second embodiment of a mulching lawn mower blade assembly;

FIG. 8a is a side view of a mulching blade portion;

FIG. 8b is a top view of the mulching blade portion shown in FIG. 8a;

FIG. 9a is a front view of a lawn mower blade portion illustrating a fourth embodiment;

FIG. 9b is a top view of the lawn mower blade portion shown in FIG. 9a;

FIG. 10a is a side view of a mulching insert in a fourth embodiment; and

FIG. 10b is a top view of the mulching insert shown in FIG. 10a.

### DETAILED DESCRIPTION OF THE INVENTION

The drawings and the following description illustrate several embodiments of the present invention. While only a portion of each embodiment may be shown and described, it should be understood that the entire embodiment includes portions which are identical when rotated one hundred-eighty degrees about a central mounting hole. Because of this fact, one skilled in the art will understand that only approximately one-half of each embodiment is shown.

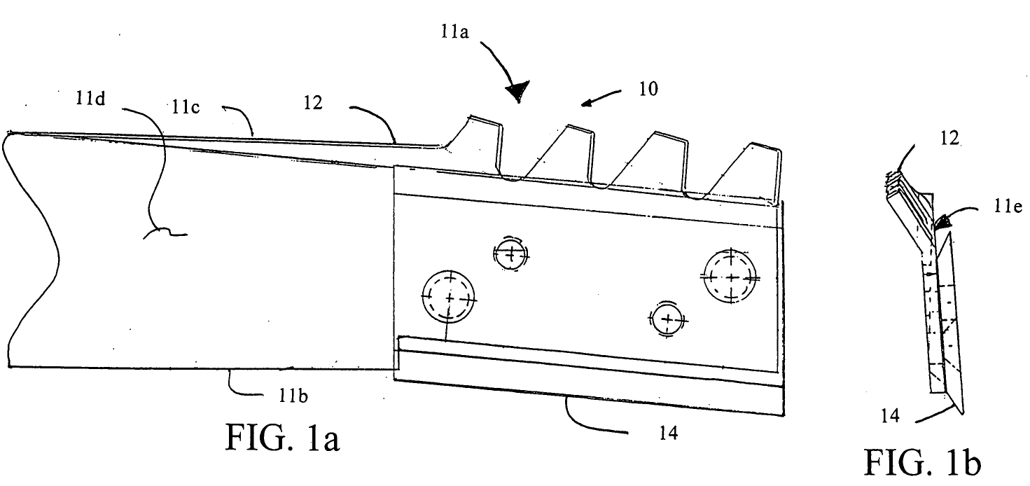

Referring now to the drawings, and initially to FIGS. 1a and 1b, a mulching lawn mower blade assembly is generally indicated by numeral 10. The mulching lawn mower blade assembly 10 is mounted in a mower housing of a lawn mower (not shown) for cutting and mulching grass. The mulching lawn mower blade assembly 10 is conveniently twenty-one inches (53 centimeters) in length, the length of a standard mower blade, but may be as short as fifteen inches (38 centimeters) or as long as thirty-six inches (91 centimeters). The mulching lawn mower blade assembly 10 includes a first terminal portion 11a, a leading edge 11b, a trailing edge 11c, a top surface 11d, and a bottom surface 11e. The mulching lawn mower blade assembly 10 also includes a second terminal portion 11f (not shown) opposite the first terminal portion 11a.

The mulching lawn mower blade assembly 10 includes a mulching blade portion 12 and an interchangeable insert 14. The insert 14 is operatively connected to the mulching blade portion 12. In the preferred embodiment, the insert 14 is attached to the mulching blade portion 12 by means of at least one locating protrusion and bolts; however, other means of attachment may readily be applied. The combination of at least one protrusion and bolts provides a convenient method of securing the insert 14 to the mulching blade portion 12 such that the locating protrusion resists all shear forces and the bolts are merely in tension. The bolts are preferably countersunk bolts having a ninety-degree head angle and a metric thread with a tensile strength of one-hundred and ten thousand pounds per square inch (759 MPa). Each bolt is torqued to between eighty and ninety inch-pounds (9-10 N·m). As can be seen in FIG. 1a, the insert 14 extends beyond the mulching blade portion 12. If the insert 14 dulls, the insert 14 may be removed, rotated and reattached. If the insert 14 is completely dull, it may be disposed of and replaced. The mulching lawn mower blade assembly 10 may be covered by liquid paint or powder coated.

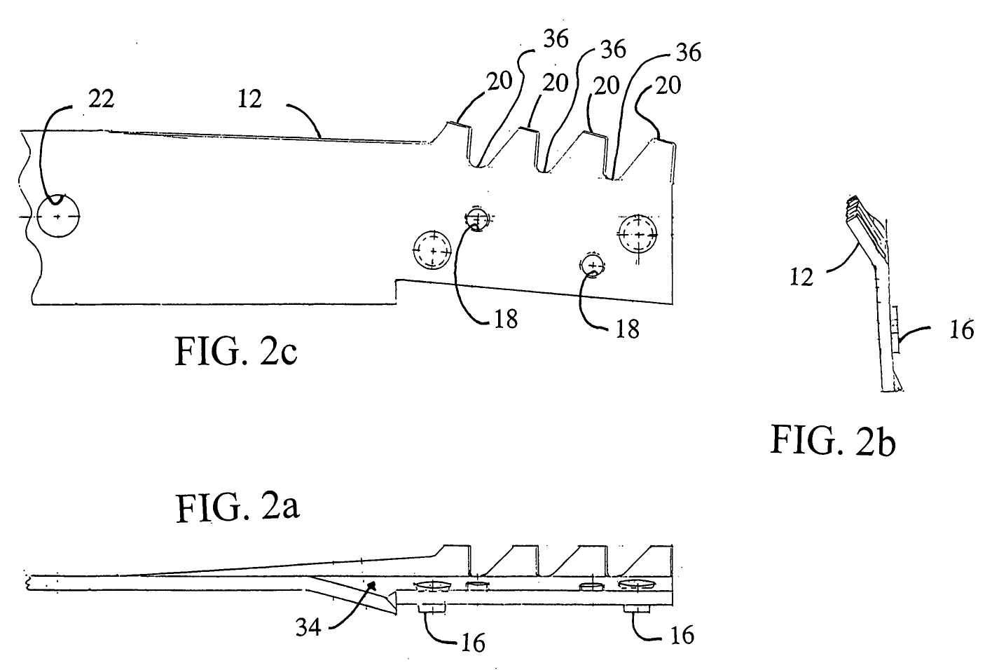

In FIGS. 2a, 2b, and 2c, a preferred embodiment of the mulching blade portion 12 is shown. A mounting hole 22 is in the center of the mulching blade portion 12. The mounting hole 22 is used to operatively connect the mulching lawn mower blade assembly 10 to the lawn mower. The mulching blade portion 12 includes two protrusions 16. The mulching blade portion 12 also includes two threaded holes 18. The mulching blade portion 12 has several mulching fingers or teeth 20. In this preferred embodiment, there are four teeth on each end of the mulching blade portion 12, but there may be as few as two teeth or as many as six teeth. The teeth 20 are bent upwards preferably at thirty degrees. The teeth 20 may be bent from ten to forty-five degrees, but at angles of forty-five degrees and greater the mulching lawn mower blade assembly 10 tends to overload the lawn mower thereby reducing blade rotation speed. The bent teeth 20 act as a fan to create a suction which evacuates or at least reduces the air pressure in the mower housing. The suction straightens bent grass blades for easier cutting and swirls around the cut grass blades for mulching purposes. Additionally, each tooth 20 may be twisted such that a sharp comer or cutting edge is slightly forward from the rest of the tooth. The teeth preferably have a thirty degree twist but other angles may be used. More efficient mulching is obtained when the teeth 20 are twisted.

A radius 36 is located between each of the bent teeth. The radius 36 provides an exit for any sand the mulching blade portion 12 may come across.

Without the radius 36, the mulching blade portion 12 would have a short service life in areas with high sand content. The mulching blade portion 12 also includes a chip guard 34 for lifting small rocks up and over the mulching lawn mower blade assembly 10. The chip guard 34 is preferably at an angle of five degrees.

The mulching blade portion 12 is manufactured by laser cutting a profile from a steel plate, such as a high carbon steel, then bending the teeth 20 and forming the protrusions 16. The mulching blade portion 12 is then heat treated to a hardness of forty to forty-five on the Rockwell C-Scale. The mulching blade portion 12 conveniently has a thickness of three-sixteenths but other thickness may be used.

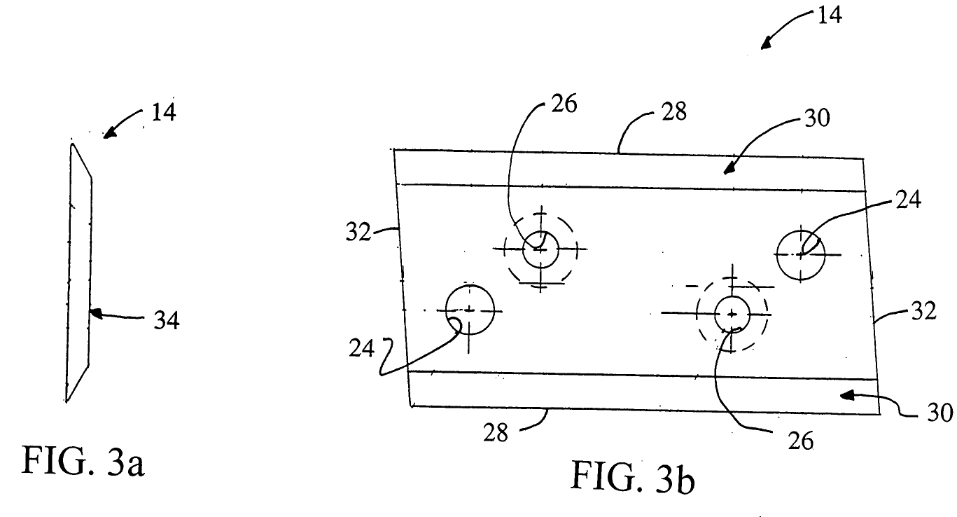

FIGS. 3a and 3b illustrate another embodiment of the insert 14. The insert 14 has a face 34. The insert 14 includes two locating holes 24 and two bolt holes 26. The bolt holes 26 are countersunk to accept the bolt head. The insert 14 includes two cutting edges 28. In this manner, the insert 14 may be removed, rotated and reattached to the mulching blade portion 12. Thus, the cutting edges 28 do not need to be re-sharpened and provide twice the cutting life of a standard blade. The cutting edges 28 are formed by cutting surfaces 30. The cutting surfaces 30 are preferably at an angle of thirty degrees to the face 34 of the insert 14. The insert 14 has two ends 32. Each end 32 is at angle of five degrees. The insert 14 is advantageously made from an abrasive resistant material, such as U.S. Steel AR-500 at RC 50 hardness. The insert 14 is laser cut from steel plate, beveled to thirty degrees on the laser heat.

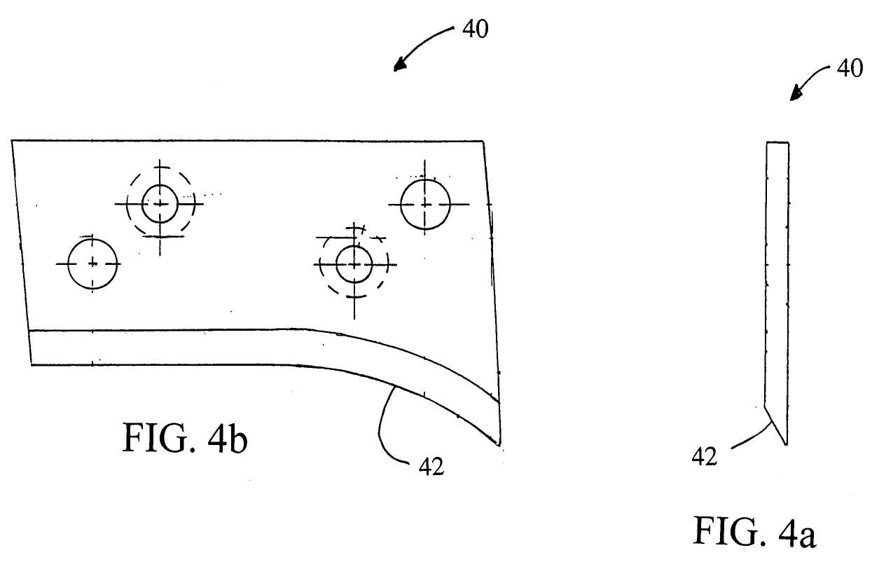

Referring now to FIGS. 4a and 4b, there is shown a sickle insert generally indicated by numeral 40. The sickle insert 40 may be used in combination with the mulching blade portion 12 instead of the insert 14. The sickle insert 40 has a special shape that does not allow the grass to escape a cutting blade 42. The curved shape of the cutting blade 42 provides increased performance in tall grass.

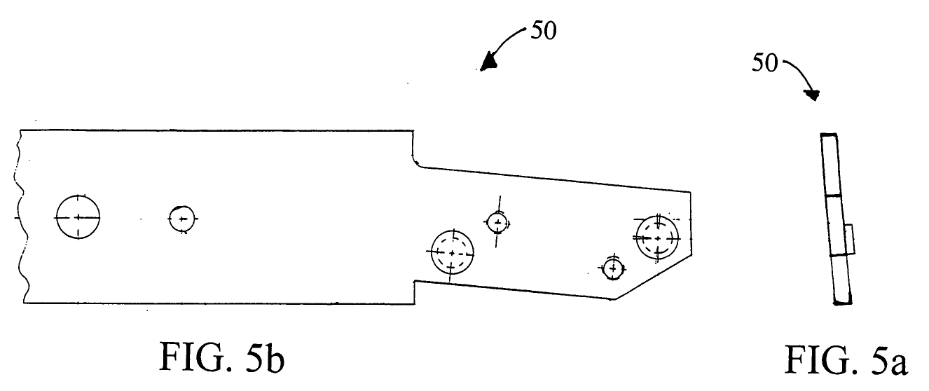

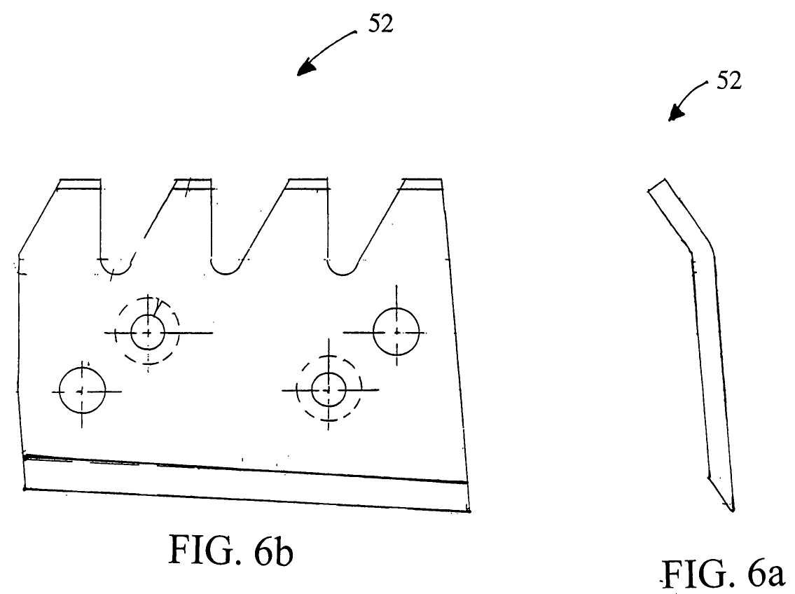

In FIGS. 5a, 5b, and FIGS. 6a and 6b, a sand mower blade portion 50 and a mulching insert 52 are shown, respectively. The sand mower blade portion 50 and the mulching insert 52 are used in combination to form the mulching lawn mower blade assembly 10. In this embodiment, the mulching teeth are located on the insert instead of the mower blade.

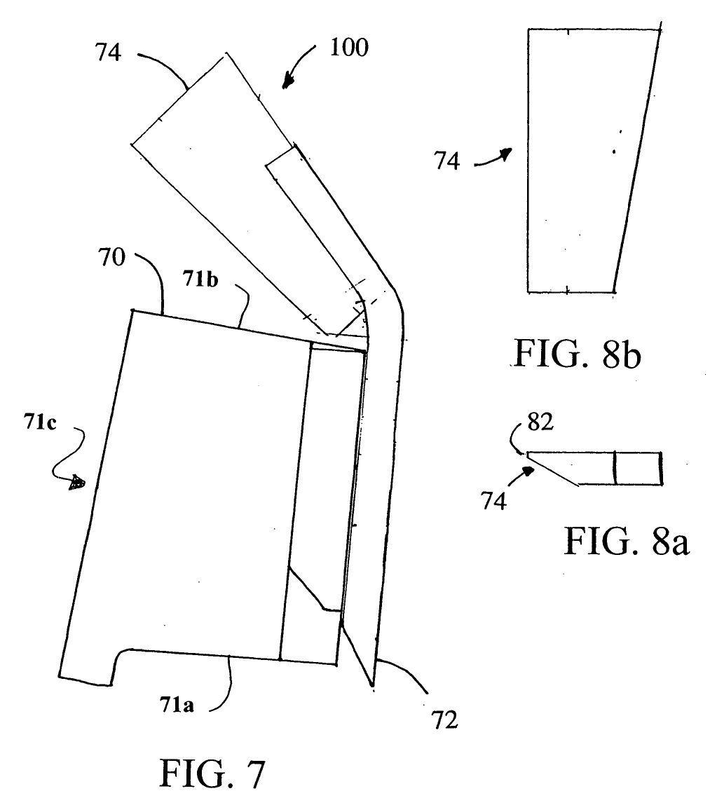

FIG. 7 illustrates a mulching rotary lawn mower blade assembly 100. A plurality of the mulching rotary lawn mower blade assembly 100 are mounted on a disc in a mower housing of a rotary lawn mower (not shown) for cutting and mulching grass. The mulching rotary brush mower blade assembly 100 includes a rotary brush mower blade portion 70, an accompanying mulching insert 72, and a mulching finger or knife 74. The rotary brush mower blade portion 70 includes a leading edge 71a, a trailing edge 71b, and a top surface 71c. The mulching insert 72 is preferably attached to the rotary brush mower blade portion 70 through the use of at least one locating protrusion and bolts but other means may be used for their connection. The mulching rotary brush mower blade assembly 100 preferably includes two mulching knives 74 on each side of the rotary brush mower blade portion 70 for enhanced performance but one skilled in the art can recognize the use of greater or fewer mulching knives. The mulching knives 74 are conveniently welded to the mulching insert 72; however, other means of operatively connecting the mulching knives 74 can be used.

FIGS. 8a and 8b show the mulching knife 74. The mulching knife 74 includes a cutting edge 82.

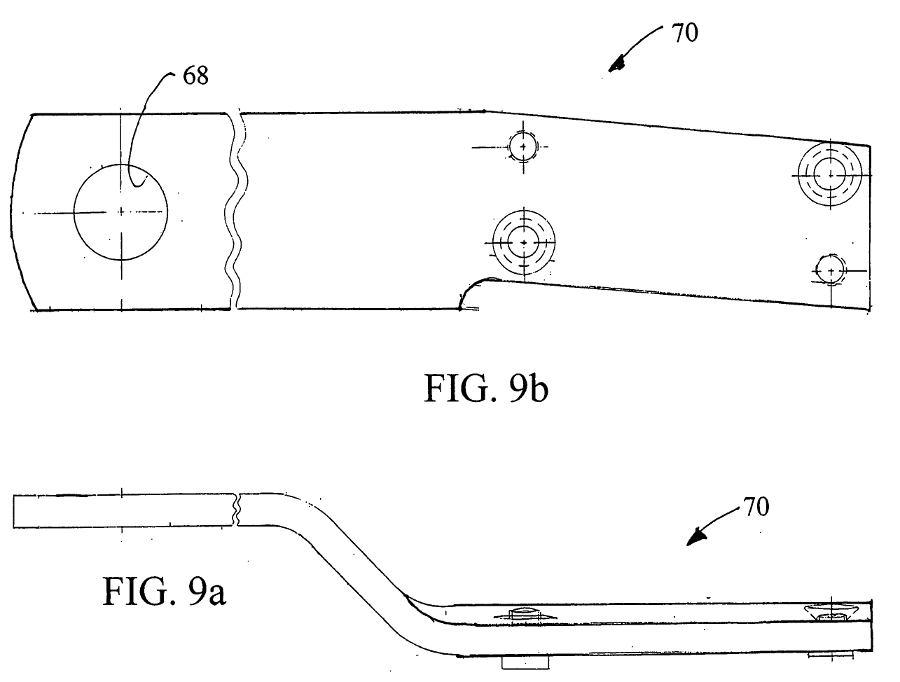

In FIGS. 9a and 9b, the rotary brush mower blade portion 70 is shown. The rotary brush mower blade portion 70 does not include mirror images about a center-line through a center hole; thus the entire embodiment is shown. This type of blade with a single cutting edge portion is used, for example, in brush hogs. The rotary brush mower blade portion 70 includes a mounting hole 68. The mounting hole 68 is used to mount the mulching rotary brush mower blade assembly 100 to the disc of the brush lawn mower.

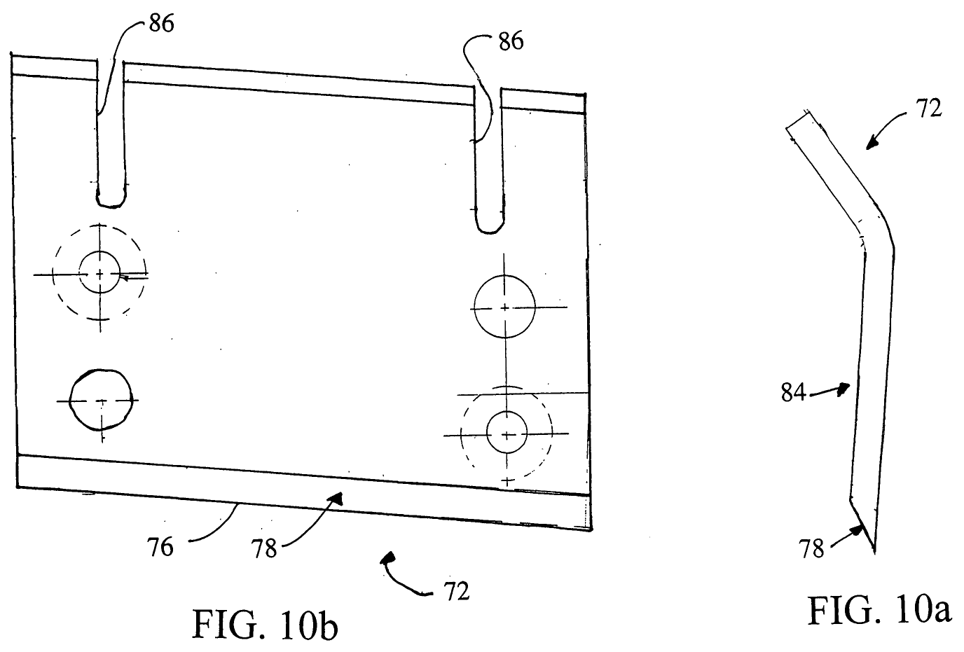

Referring now to FIGS. 10a and 10b, the mulching insert 72 is shown. The mulching insert 72 includes a cutting edge 76. The cutting edge 76 is formed by a cutting surface 78. The cutting surface 78 is preferably at an angle of thirty degrees to an insert face 84. The mulching insert also includes a groove 86. There are preferably two grooves 86. The grooves 86 provide a location for attachment of the mulching knives 74.

In summary, the mulching lawn mower blade assembly includes a blade portion, a removable insert associated with the blade portion, and inclined mulching fingers associated with either the blade portion or the removable insert. The mulching fingers may take the form of mulching teeth, or the mulching fingers may take the form of mulching knives.

Other aspects, objects and advantages of the present invention can be obtained from a study of the drawings, the disclosure and the accompanying claims. The invention in its broader aspects is not limited to the specific steps and apparatus shown and described but departures may be made therefrom within the scope of the accompanying claims without departing from the principles of the invention and without sacrificing its chief advantages.

What is claimed is:

1. A mulching lawn mower blade assembly having a leading edge, a trailing edge opposite the leading edge, a first terminal portion, a second terminal portion opposite the first terminal portion, a top surface, and a bottom surface opposite the top surface, the mulching lawn mower blade assembly comprising:
a blade portion, said blade portion including a mounting hole;
at least one removable insert operatively connected to said blade portion at the first terminal portion and along the bottom surface, said at least one removable insert having at least one sharpened edge that extends beyond the leading edge; and
a plurality of inclined mulching fingers located at the first terminal portion or the second terminal portion, said plurality of inclined mulching fingers being operatively connected to said blade portion or to said at least one removable insert and proximate to the trailing edge.

2. The mulching lawn mower blade assembly according to claim 1, wherein said plurality of inclined mulching fingers is operatively connected to said blade portion.

3. The mulching lawn mower blade assembly according to claim 1, wherein said plurality of inclined mulching fingers is operatively connected to said at least one removable insert.

4. The mulching lawn mower blade assembly according to claim 1, wherein said plurality of inclined mulching fingers extend transversely from the top surface.

5. The mulching lawn mower blade assembly according to claim 1, wherein a length of said blade portion has a length in a range from about 15 inches to about 36 inches.

6. The mulching lawn mower blade assembly according to claim 1, wherein said blade portion includes at least one protrusion for securing said at least one removable insert.

7. The mulching lawn mower blade assembly according to claim 1, further comprising a chip guard.

8. The mulching lawn mower blade assembly according to claim 1, wherein said at least one removable insert includes a first cutting edge and a second cutting edge.

9. The mulching lawn mower blade assembly according to claim 1, wherein said at least one removable insert is sickle-shaped.

10. The mulching lawn mower blade assembly according to claim 1, wherein each of said plurality of inclined mulching fingers is a mulching knife.

11. The mulching lawn mower blade assembly according to claim 10, wherein said at least one removable insert includes a plurality of grooves for receiving said plurality of mulching knives.

12. The mulching lawn mower blade assembly according to claim 1, wherein each of said plurality of inclined mulching fingers is a mulching tooth.

13. The mulching lawn mower blade assembly according to claim 12, wherein said blade portion includes four mulching teeth.

14. The mulching lawn mower blade assembly according to claim 12, wherein said plurality of inclined mulching teeth are inclined at about thirty degrees.

15. The mulching lawn mower blade assembly according to claim 14, wherein there are a first removable insert located at the first terminal portion and a second removable insert located at the second terminal portion.

16. The mulching lawn mower blade assembly according to claim 14, wherein each tooth of said plurality of inclined mulching teeth has a twist and a radius located between at least two of said plurality of inclined mulching teeth.

17. The mulching lawn mower blade assembly according to claim 16, wherein said twist is about thirty degrees.

18. A removable insert being adapted for mounting on a lawn mower blade, the removable insert having a leading edge, a trailing edge opposite the leading edge, a top surface, and a bottom surface opposite the top surface, the removable insert comprising:
an inclined cutting surface located along said leading edge; and
a plurality of inclined mulching fingers located at the trailing edge and extending transversely from the top surface.

19. The removable insert according to claim 16, wherein each of said plurality of inclined mulching fingers is a mulching knife.

20. The removable insert according to claim 17, wherein the removable insert includes a plurality of grooves for receiving said plurality of mulching knives.

21. The removable insert according to claim 1, wherein each of said plurality of inclined mulching fingers is a mulching tooth.

22. The removable insert according to claim 19, wherein said blade portion includes four mulching teeth.

23. The removable insert according to claim 19, wherein said plurality of inclined mulching teeth are inclined at about thirty degrees.

24. A method of assembling a lawn mower comprising the steps of:
providing a housing;
connecting a motor having a shaft to said housing;
connecting a blade portion to said shaft; and
connecting a removable insert having a plurality of mulching fingers to said blade portion.
